(19) United States
(12) Patent Application Publication
(10) Pub. No.: US 2024/0334202 A1
(43) Pub. Date: Oct. 3, 2024

(54) SYSTEM RESOURCE MANAGEMENT THROUGH AUTOMATED HARDWARE DECOMMISSIONING AND COMMISSIONING

(71) Applicant: Rakuten Symphony India Private Limited, Indore (IN)

(72) Inventors: Sameer PANCHOLI, Indore (IN); Harish SABLANI, Indore (IN)

(73) Assignee: Rakuten Symphony India Private Limited, Indore (IN)

(21) Appl. No.: 18/192,883

(22) Filed: Mar. 30, 2023

(51) Int. Cl. H04W 24/02

(52) U.S. Cl. CPC H04W 24/02

(57) ABSTRACT

Provided is a system and method for managing resources of a radio access network (RAN) which includes: monitoring the RAN; identifying a piece of equipment within the RAN that is not functioning in a normal manner; based on identifying the piece of equipment that is not functioning in a normal manner, initiating an alert to a user and generating a request to decommission the identified piece of equipment; requesting approval of the request to decommission the identified piece of equipment and to commission a replacement for the identified piece of equipment; and, based on receiving approval of the request to decommission the identified piece of equipment and to commission a replacement for the identified piece of equipment, initiating decommissioning of the identified piece of equipment and commissioning of the replacement for the identified piece of equipment.

### TECHNICAL FIELD

The present disclosure relates to systems and methods consistent with example embodiments presented herein which relate to the automation of decommissioning of old hardware and the commissioning of new hardware within a radio access network (RAN).

### BACKGROUND ART

Currently, when hardware components of a RAN are replaced with new components, there is no automated method of properly decommissioning the old equipment and commissioning the new equipment within the RAN operator's systems. This is particularly problematic in modern systems where field hardware is often supported by cloud-based computing services that allocate memory for support of certain field equipment, as efficient system management requires timely reallocation of system resources. Therefore, the failure to properly decommissioning/commission in a timely manner can result in inefficient use of system support resources. Therefore, there is a need for an automated system the coordinates the replacement of field equipment in a RAN with the decommissioning of old equipment, and the commissioning of new equipment, within the Operational Support System (OSS) of the RAN.

### SUMMARY

According to embodiments, systems and methods are provided for identifying malfunctioning equipment within a RAN and initiating an automated process to decommission the malfunctioning equipment and commission new equipment to replace the malfunctioning equipment.

According to an aspect of the disclosure, a system for managing resources includes: a radio access network (RAN) comprising a plurality of pieces of equipment; an equipment monitoring system (EMS) configured to monitor the plurality of pieces of equipment and provide system resources in support of the operation of the plurality of pieces of equipment; at least one memory configured to store at least one instruction; and at least one processor configured to access the at least one memory and execute the at least one instruction to: monitor the plurality of pieces of equipment, identify a piece of equipment among the plurality of pieces of equipment that is not functioning in a normal manner, on identifying the piece of equipment that is not functioning in a normal manner, initiate an alert to a user and generate a request to decommission the identified piece of equipment, request approval of the request to decommission the identified piece of equipment and to commission a replacement for the identified piece of equipment, and based on receiving approval of the request to decommission the identified piece of equipment and to commission a replacement for the identified piece of equipment, initiate decommissioning of the identified piece of equipment and commissioning of the replacement for the identified piece of equipment.

According to another aspect of the disclosure, a method for managing resources of a radio access network (RAN) includes: monitoring the RAN; identifying a piece of equipment within the RAN that is not functioning in a normal manner; based on identifying the piece of equipment that is not functioning in a normal manner, initiating an alert to a user and generating a request to decommission the identified piece of equipment; requesting approval of the request to decommission the identified piece of equipment and to commission a replacement for the identified piece of equipment; and based on receiving approval of the request to decommission the identified piece of equipment and to commission a replacement for the identified piece of equipment, initiating decommissioning of the identified piece of equipment and commissioning of the replacement for the identified piece of equipment.

According to another aspect of the disclosure, a non-transitory computer readable medium having instructions stored therein, which when executed by a processor cause the processor to execute a method of managing resources of a radio access network (RAN) which includes: monitoring the RAN; identifying a piece of equipment within the RAN that is not functioning in a normal manner; based on identifying the piece of equipment that is not functioning in a normal manner, initiating an alert to a user and generating a request to decommission the identified piece of equipment; requesting approval of the request to decommission the identified piece of equipment and to commission a replacement for the identified piece of equipment; and based on receiving approval of the request to decommission the identified piece of equipment and to commission a replacement for the identified piece of equipment, initiating decommissioning of the identified piece of equipment and commissioning of the replacement for the identified piece of equipment.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 is diagram illustrating a first portion of a hardware replacement process according to an embodiment of the disclosure;

FIG. 2 is a diagram of a decommissioning/commissioning process within OSS according to an embodiment of the disclosure;

FIG. 3 is a diagram of a more detailed view of a decommissioning/commissioning workflow according to an embodiment of the disclosure;

FIG. 4 is a diagram of a return workflow according to an embodiment of the disclosure;

FIGS. 5A-5G are diagrams of a user interface for completing a Decommissioning and Commissioning Request and a Decommissioning and Commissioning Approval according to an embodiment of the disclosure;

FIG. 6 is a diagram of an example environment in which systems and/or methods, described herein, may be implemented;

FIG. 7 is a diagram of example components of a device according to an embodiment; and

FIG. 8 is a diagram describing a method of implementing a decommissioning/commissioning process according to an embodiment of the disclosure.

### DETAILED DESCRIPTION

The following detailed description of example embodiments refers to the accompanying drawings. The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Example embodiments of the present disclosure provide a method and system for providing an automated process for identifying faulty equipment, decommissioning the faulty equipment, and commission replacement equipment, where the decommissioning/commissioning process involves the reallocation of system resources previously associated with the faulty equipment to support the replacement equipment.

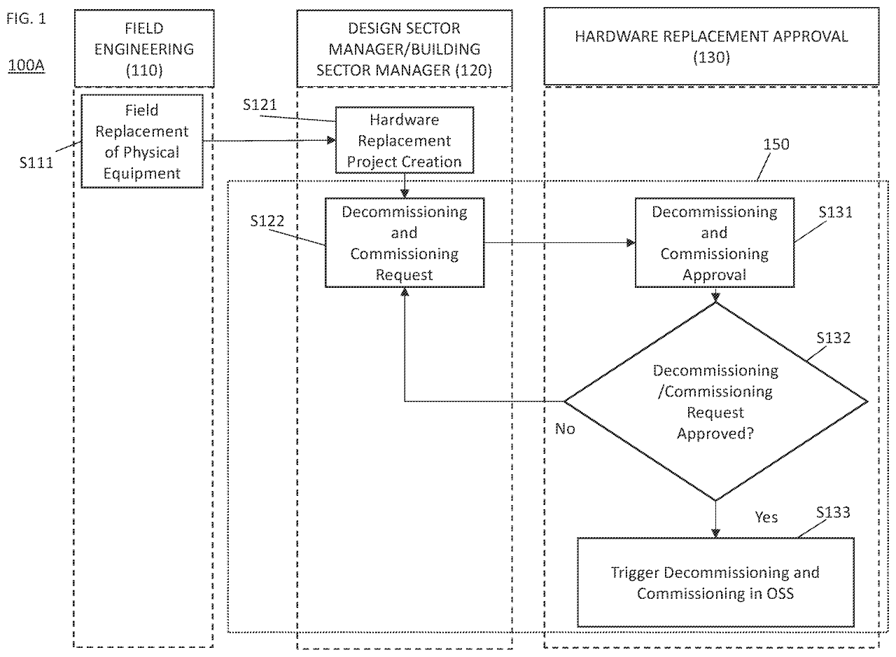

FIG. 1 is a diagram illustrating a first portion of a hardware replacement process according to an embodiment of the disclosure. Specifically, FIG. illustrates hardware replacement process 100A divided between three separate domains: Field Engineering 110, Design Sector Manager/Building Sector Manager 120, and Hardware Replacement Approval 130. Field Engineering 110 encompasses the act of physically identifying and replacing equipment in the field (S111) such as radio equipment found at a wireless network base station. For example, on a field site that is operating (e.g., a RAN base station), if any hardware failure happens then a user will replace that failed hardware with new hardware by using a hardware replacement work flow.

Replacement of field equipment (S111) triggers, either automatically as part of the field work order process or via other methods, hardware replacement project creation (S121) by the Design Sector Manager/Building Sector Manager 120. This may include generation of an automatic alarm by system if the hardware in question is no longer properly operating, and the system may prompt a user to address this alarm. The system may also generate an auto suggestion to the user indicating a warehouse location which is nearest to the site where the equipment failure happened.

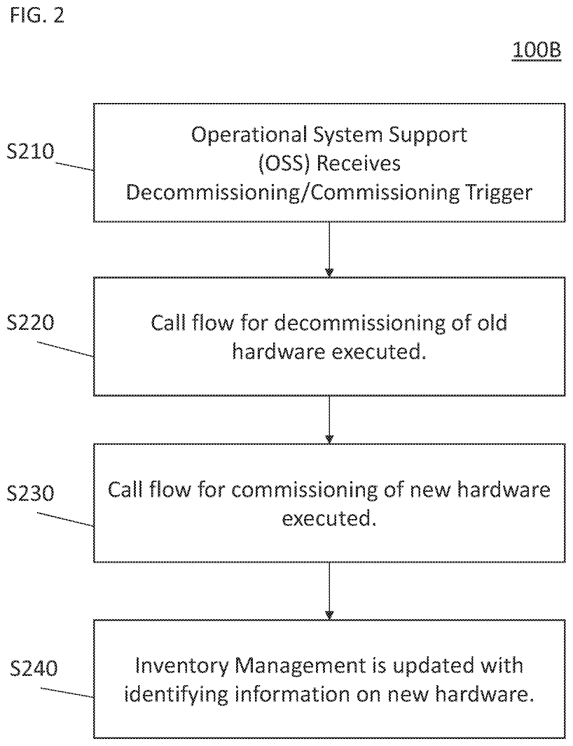

Once the hardware replacement project is created, a decommissioning and commissioning request is generated (S121), which triggers hardware replacement workflow 150. Hardware replacement workflow 150 includes generation of a decommissioning request for the equipment to be replaced and a commissioning request for the new equipment to be installed in its place (S122). Once generation of the decommissioning/commissioning request is complete, decommissioning/commissioning approval (S131) is required. If approval is granted, then a trigger to commence decommissioning/commissioning is sent to OSS (see FIG. 2).

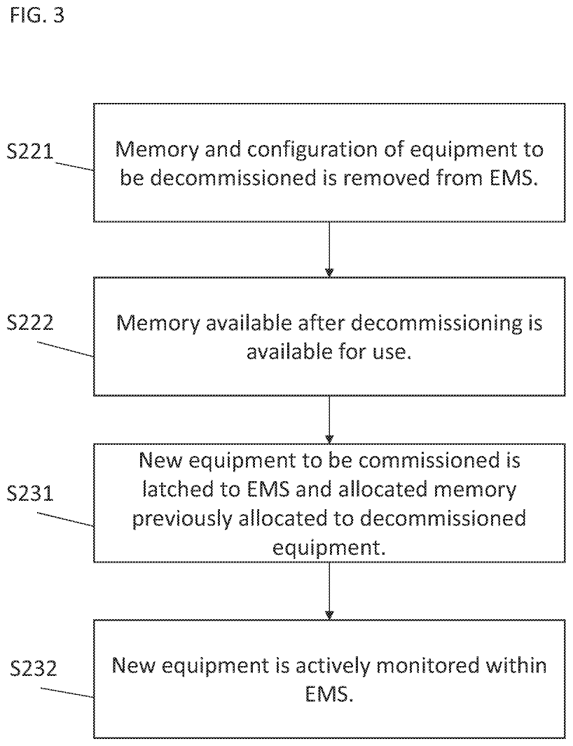

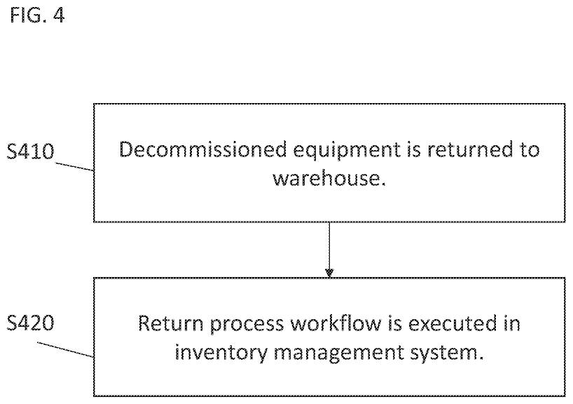

FIG. 2 is a diagram of a decommissioning/commissioning process within OSS according to an embodiment. FIG. 3 is a diagram of a more detailed view of a decommissioning/commissioning workflow according to an embodiment. FIG. 4 is a diagram of a return workflow according to an embodiment. Once the trigger to commence decommissioning/commissioning is received by OSS (S210), a call flow for decommissioning of the old equipment is initiated (S220). The trigger to commence decommissioning/commissioning will include all relevant information associated with the decommissioned equipment and the new equipment, such as serial number, MAC address, etc. As shown in FIG. 3, this call flow includes removal of memory and configuration information associated with the decommissioned equipment from the Equipment Monitoring System (EMS) (S221). In an embodiment, this includes deallocation of any virtual resources or memory allocated to the decommissioned equipment, for example cloud-based resources or resources on a remote server or resources in the EMS such as EMS system memory, EMS processor time, or EMS virtual machine resources (these are just examples, and the disclosure is not limited to these specific resources). Once decommissioning is complete, the memory and other resources previously allocated to the decommissioned equipment are made available for reallocation (S222). The new equipment to be commissioned is then latched or otherwise tied to the EMS, and the memory and other system resources previously allocated to the decommissioned equipment is reallocated to the new equipment (S231). The new equipment is then actively monitored by, and otherwise interacts with, the EMS (S232). Finally, the Inventory Management System is updated to track the newly-commissioned equipment (S240).

In an embodiment, the update of the Inventory Management System (S240) includes a return workflow as shown in FIG. 4. Specifically, the decommissioned equipment is returned to a centralized warehouse (S410), and a return workflow is executed via the Inventory Management System; for example, to obtain relief under any manufacturer warranty program or other repair/replace program associated with the decommissioned equipment.

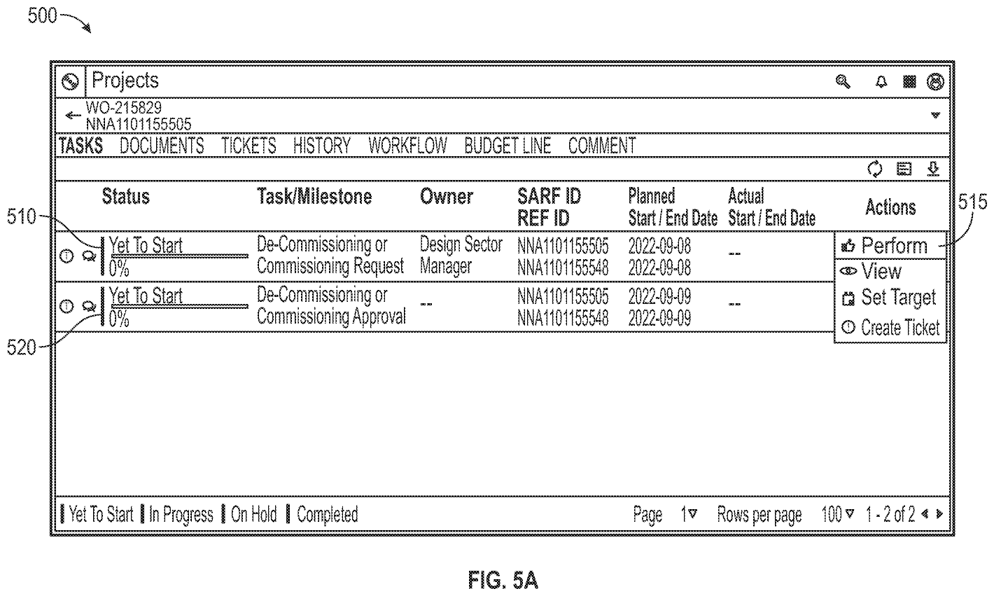

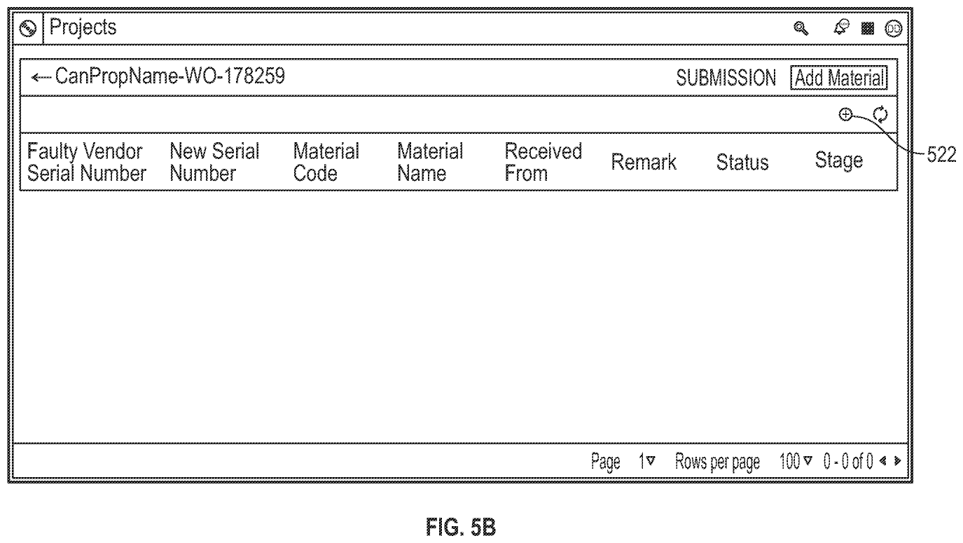

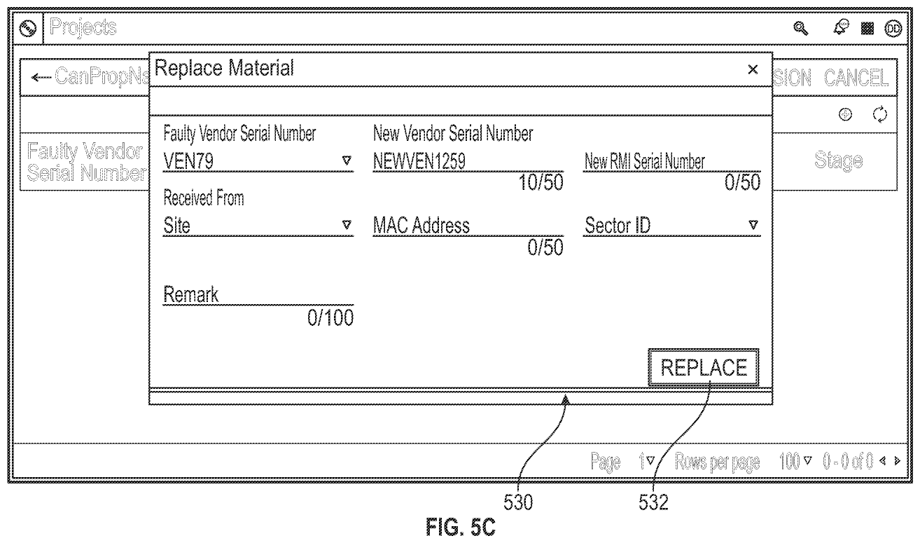

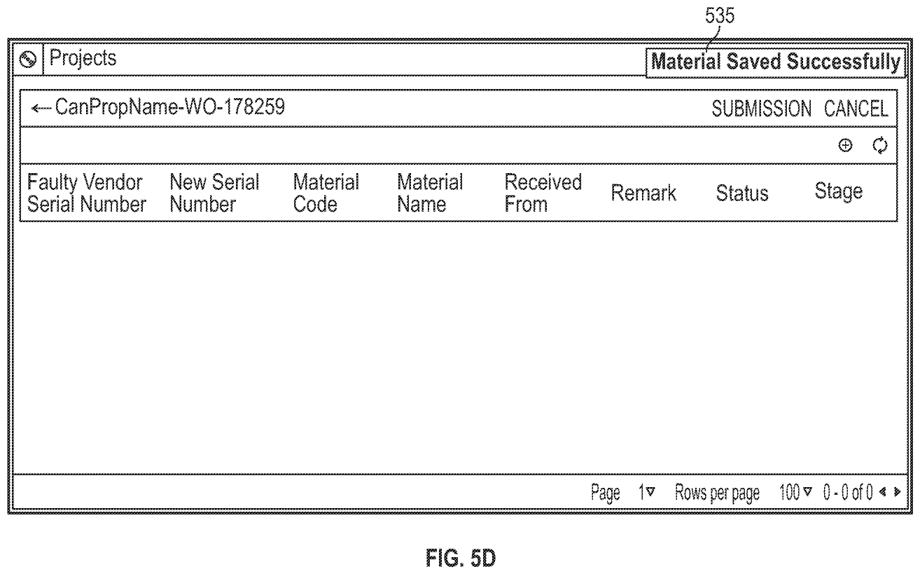

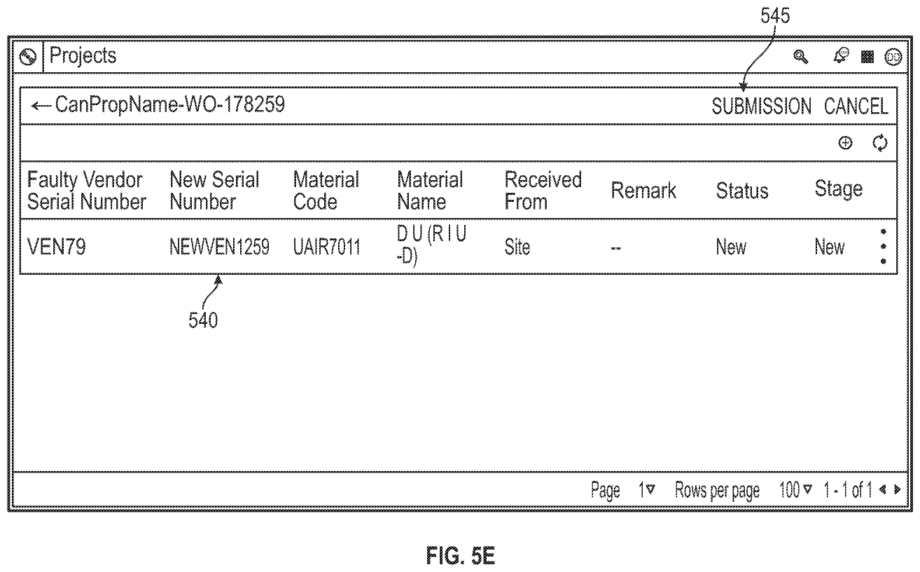

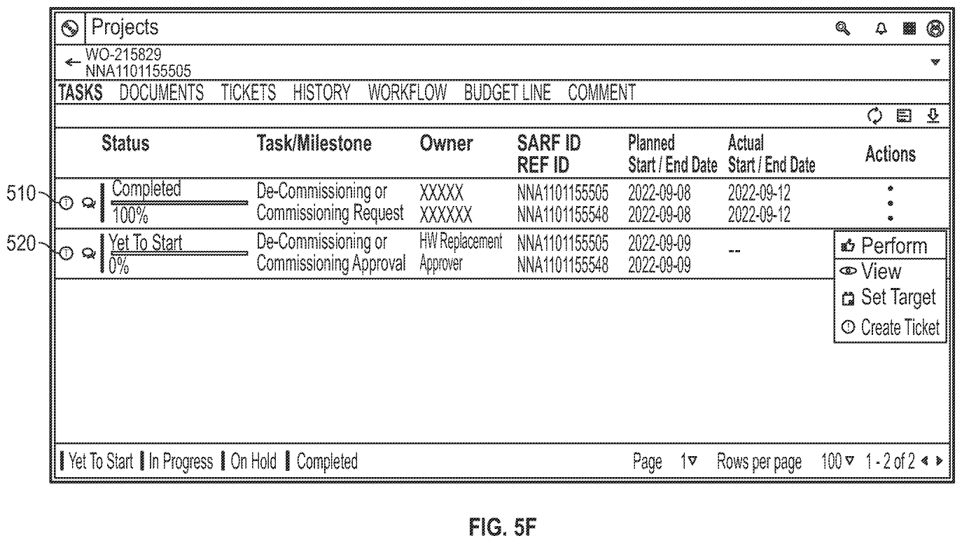

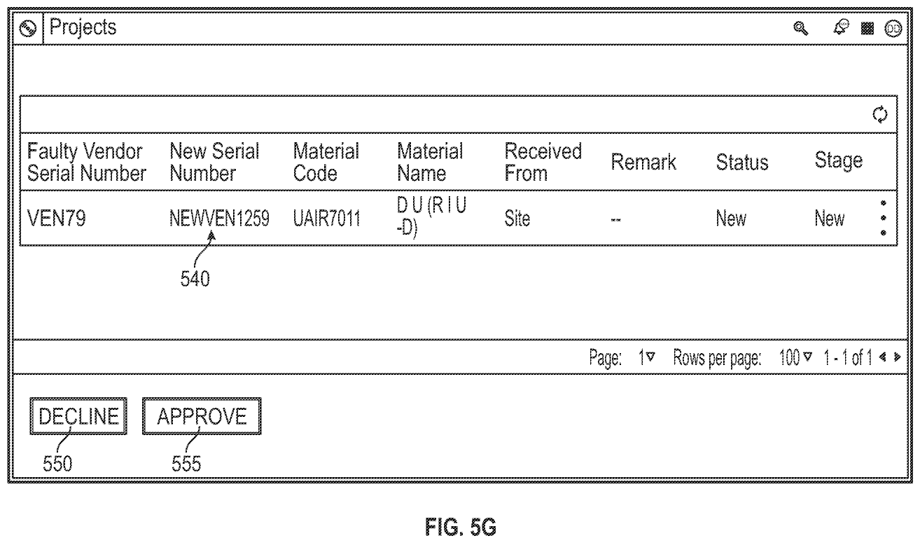

FIGS. 5A-5G show images of a user interface for completing a Decommissioning and Commissioning Request and a Decommissioning and Commissioning Approval according to an embodiment of the disclosure. FIG. 5A shows a user interface 500 displaying two tasks, namely a Decommissioning or Commissioning Request 510 and a Decommissioning or Commissioning Approval 520. A call-down box 515 allows the user to perform the Decommissioning or Commissioning Request 510 by selecting “Perform”.

FIG. 5B shows an initial page associated with Decommissioning or Commissioning Request 510 where information related to the equipment in question has not yet been entered. Selection of “Add” button 522 allows the user to enter information on the equipment in question. Specifically, a dialog box 530 is opened (FIG. 5C) that allows the user to enter information on the equipment to be replaced and the new equipment to be commissioned into service. This information incudes, but is not limited to, the serial number of the faulty equipment, the serial number of the new equipment, any internal serial numbers or equipment tracking numbers, the MAC address, etc. Once complete, the user can click the “Replace” button 532. This then generates an indicator 535 that the information has been saved (FIG. 5D). Once the information 540 is populated, the user clicks the “Submission” button 545 to complete Decommissioning or Commissioning Request 510.

FIG. 5F shows Decommissioning or Commissioning Request 510 as 100% completed. Once Decommissioning or Commissioning Request 510 is complete, a user with authorization to complete Decommissioning or Commissioning Approval 520 is able to access this task to approve or decline the Request 510. As shown on FIG. 5G, the reviewer is able to see information 540 previously entered with Request 510, and select either the “Decline” button 550 or the “Approve” button 555. Once approved, the trigger to initiate decommissioning/commissioning will be sent to the OSS (see, e.g, FIGS. 2-4).

In an embodiment, the information for entry of information related to equipment to be decommissioned and/or commissioned can be automatically populated via other system management tools or databases. For example, a system for managing work orders for physical equipment replacement could automatically generate Decommissioning or Commissioning Request 510 and populate all relevant fields as part of the generation process.

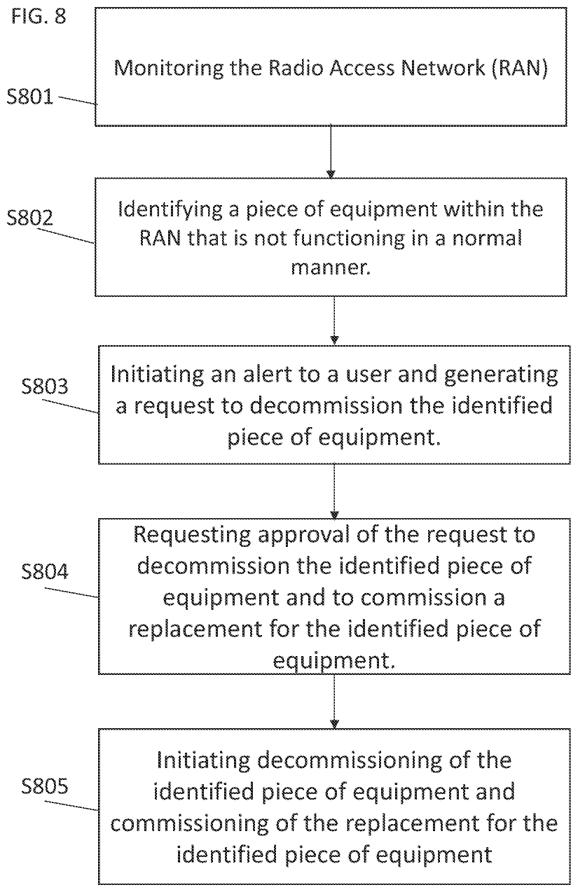

FIG. 8 is a diagram describing a method of implementing a decommissioning/commissioning process according to an embodiment of the disclosure. According to an embodiment of the disclosure, a method for managing resources of a radio access network (RAN) includes monitoring the RAN (S801); identifying a piece of equipment within the RAN that is not functioning in a normal manner (S802); based on identifying the piece of equipment that is not functioning in a normal manner, initiating an alert to a user and generating a request to decommission the identified piece of equipment (S803); requesting approval of the request to decommission the identified piece of equipment and to commission a replacement for the identified piece of equipment (S804; and based on receiving approval of the request to decommission the identified piece of equipment and to commission a replacement for the identified piece of equipment, initiating decommissioning of the identified piece of equipment and commissioning of the replacement for the identified piece of equipment (S805).

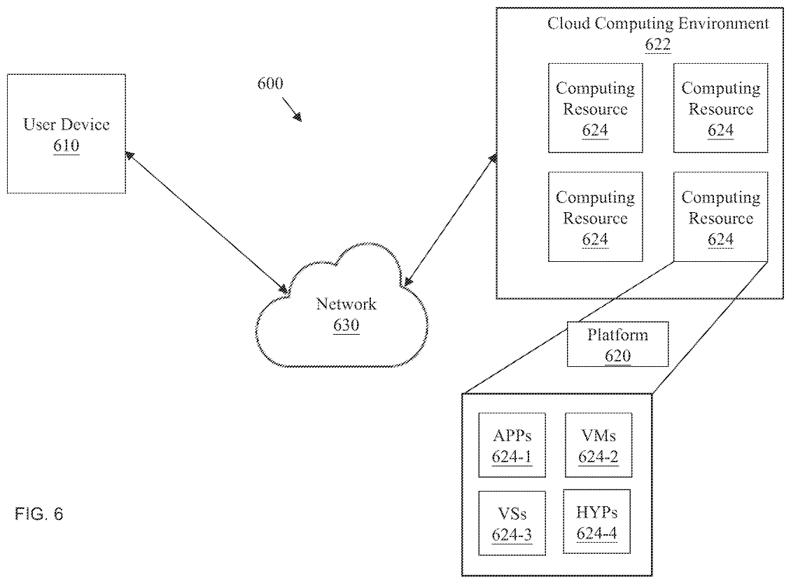

FIG. 6 is a diagram of an example environment 600 in which systems and/or methods, described herein, may be implemented. As shown in FIG. 6, environment 600 may include a user device 610, a platform 620, and a network 630. Devices of environment 600 may interconnect via wired connections, wireless connections, or a combination of wired and wireless connections. In embodiments, any of the functions and operations described with reference to FIGS. 1-5G above may be performed by any combination of elements illustrated in FIG. 6.

User device 610 includes one or more devices capable of receiving, generating, storing, processing, and/or providing information associated with platform 620. For example, user device 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 610 may receive information from and/or transmit information to platform 620.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc., services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like.

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 includes one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

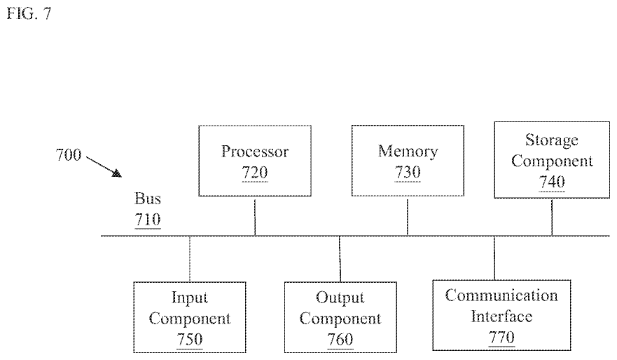

FIG. 7 is a diagram of example components of a device 700. Device 700 may correspond to user device 610 and/or platform 620. As shown in FIG. 7, device 700 may include a bus 710, a processor 720, a memory 730, a storage component 740, an input component 750, an output component 760, and a communication interface 770.

Bus 710 includes a component that permits communication among the components of device 700. Processor 720 may be implemented in hardware, firmware, or a combination of hardware and software. Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 includes one or more processors capable of being programmed to perform a function. Memory 730 includes a random access memory (RAM), a read only memory (ROM), and/or another type of dynamic or static storage device (e.g., a flash memory, a magnetic memory, and/or an optical memory) that stores information and/or instructions for use by processor 720.

Storage component 740 stores information and/or software related to the operation and use of device 700. For example, storage component 740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 750 includes a component that permits device 700 to receive information, such as via user input (e.g., a touch screen display, a keyboard, a keypad, a mouse, a button, a switch, and/or a microphone). Additionally, or alternatively, input component 750 may include a sensor for sensing information (e.g., a global positioning system (GPS) component, an accelerometer, a gyroscope, and/or an actuator). Output component 760 includes a component that provides output information from device 700 (e.g., a display, a speaker, and/or one or more light-emitting diodes (LEDs)).

Communication interface 770 includes a transceiver-like component (e.g., a transceiver and/or a separate receiver and transmitter) that enables device 700 to communicate with other devices, such as via a wired connection, a wireless connection, or a combination of wired and wireless connections. Communication interface 770 may permit device 700 to receive information from another device and/or provide information to another device. For example, communication interface 770 may include an Ethernet interface, an optical interface, a coaxial interface, an infrared interface, a radio frequency (RF) interface, a universal serial bus (USB) interface, a Wi-Fi interface, a cellular network interface, or the like.

Device 700 may perform one or more processes described herein. Device 700 may perform these processes in response to processor 720 executing software instructions stored by a non-transitory computer-readable medium, such as memory 730 and/or storage component 740. A computer-readable medium is defined herein as a non-transitory memory device. A memory device includes memory space within a single physical storage device or memory space spread across multiple physical storage devices.

Software instructions may be read into memory 730 and/or storage component 740 from another computer-readable medium or from another device via communication interface 770. When executed, software instructions stored in memory 730 and/or storage component 740 may cause processor 720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

In embodiments, any one of the operations or processes of FIGS. 1-5G and 8 may be implemented by or using any one of the elements illustrated in FIGS. 6 and 7. It is understood that other embodiments are not limited thereto, and may be implemented in a variety of different architectures (e.g., bare metal architecture, any cloud-based architecture or deployment architecture such as Kubernetes, Docker, OpenStack, etc.).

According to the several embodiments described herein, a RAN system may be monitored to identify malfunctioning equipment. Once identified, an automated process is triggered to decommission the malfunctioning equipment and to commission any new equipment installed replacing the malfunctioning equipment. This decommissioning/commissioning process ensures timely reallocation of system resources, which is important in the operation of a modern RAN where field equipment is often supported by remote and/or virtual resources. By automating this process, the system operator prevents inefficient use of system resources when field equipment is replaced.

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.
[1] A system for managing resources, the system comprising: a radio access network (RAN) comprising a plurality of pieces of equipment; an equipment monitoring system (EMS) configured to monitor the plurality of pieces of equipment and provide system resources in support of the operation of the plurality of pieces of equipment; at least one memory configured to store at least one instruction; and at least one processor configured to access the at least one memory and execute the at least one instruction to: monitor the plurality of pieces of equipment, identify a piece of equipment among the plurality of pieces of equipment that is not functioning in a normal manner, on identifying the piece of equipment that is not functioning in a normal manner, initiate an alert to a user and generate a request to decommission the identified piece of equipment, request approval of the request to decommission the identified piece of equipment and to commission a replacement for the identified piece of equipment, and based on receiving approval of the request to decommission the identified piece of equipment and to commission a replacement for the identified piece of equipment, initiate decommissioning of the identified piece of equipment and commissioning of the replacement for the identified piece of equipment.
[2] The system of [1], wherein the decommissioning of the identified piece of equipment comprises: identification of EMS system resources allocated to the identified piece of equipment, and deallocation of the identified EMS system resources.
[3] The system of [3], wherein the commissioning of the replacement for the identified piece of equipment comprises: allocation of the identified EMS system resources to the replacement for the identified piece of equipment, and monitoring the replacement for the identified piece of equipment by the EMS.
[4] The system of [1], [2], or [3], wherein the request to decommission the identified piece of equipment comprises at least one of information on the identified piece of equipment and information on the replacement for the identified piece of equipment.
[5] The system of [4], wherein the information on the identified piece of equipment comprises at least one of a serial number of the identified piece of equipment, a location of the identified piece of equipment, and a MAC address of the identified piece of equipment, and wherein the information on the replacement for the identified piece of equipment comprises at least one of a serial number of the replacement for the identified piece of equipment and a MAC address of the replacement for the identified piece of equipment.
[6] The system of [4] or [5], wherein the information on the identified piece of equipment and the information on the replacement for the identified piece of equipment are automatically retrieved from the EMS.
[7] The system of [4] or [5], wherein the information on the identified piece of equipment and the information on the replacement for the identified piece of equipment are provided by a user.
[8] A method for managing resources of a radio access network (RAN), the method comprising: monitoring the RAN; identifying a piece of equipment within the RAN that is not functioning in a normal manner; based on identifying the piece of equipment that is not functioning in a normal manner, initiating an alert to a user and generating a request to decommission the identified piece of equipment; requesting approval of the request to decommission the identified piece of equipment and to commission a replacement for the identified piece of equipment; and based on receiving approval of the request to decommission the identified piece of equipment and to commission a replacement for the identified piece of equipment, initiating decommissioning of the identified piece of equipment and commissioning of the replacement for the identified piece of equipment.
[9] The method of [8], wherein the decommissioning of the identified piece of equipment comprises: identifying equipment monitoring system (EMS) system resources allocated to the identified piece of equipment; and deallocating the identified EMS system resources.
[10] The method of [9], wherein the commissioning of the replacement for the identified piece of equipment comprises: allocating the identified EMS system resources to the replacement for the identified piece of equipment; and monitoring the replacement for the identified piece of equipment by the EMS.
[11] The method of [8], [9], or [10], wherein the request to decommission the identified piece of equipment comprises at least one of information on the identified piece of equipment and information on the replacement for the identified piece of equipment.
[12] The method of [11], wherein the information on the identified piece of equipment comprises at least one of a serial number of the identified piece of equipment, a location of the identified piece of equipment, and a MAC address of the identified piece of equipment, and wherein the information on the replacement for the identified piece of equipment comprises at least one of a serial number of the replacement for the identified piece of equipment and a MAC address of the replacement for the identified piece of equipment.
[13] The method of [11] or [12], wherein the information on the identified piece of equipment and the information on the replacement for the identified piece of equipment are automatically retrieved from the EMS.
[14] The method of or [12], wherein the information on the identified piece of equipment and the information on the replacement for the identified piece of equipment are provided by a user.
[15] A non-transitory computer readable medium having instructions stored therein, which when executed by a processor cause the processor to execute a method of managing resources of a radio access network (RAN), the method comprising: monitoring the RAN; identifying a piece of equipment within the RAN that is not functioning in a normal manner; based on identifying the piece of equipment that is not functioning in a normal manner, initiating an alert to a user and generating a request to decommission the identified piece of equipment; requesting approval of the request to decommission the identified piece of equipment and to commission a replacement for the identified piece of equipment; and based on receiving approval of the request to decommission the identified piece of equipment and to commission a replacement for the identified piece of equipment, initiating decommissioning of the identified piece of equipment and commissioning of the replacement for the identified piece of equipment.
[16] The non-transitory computer readable medium of [15], wherein the decommissioning of the identified piece of equipment comprises: identifying equipment monitoring system (EMS) system resources allocated to the identified piece of equipment; and deallocating the identified EMS system resources.
[17] The non-transitory computer readable medium of [16], wherein the commissioning of the replacement for the identified piece of equipment comprises: allocating the identified EMS system resources to the replacement for the identified piece of equipment; and monitoring the replacement for the identified piece of equipment by the EMS.
[18] The non-transitory computer readable medium of [15], or [17], wherein the request to decommission the identified piece of equipment comprises at least one of information on the identified piece of equipment and information on the replacement for the identified piece of equipment.
[19] The non-transitory computer readable medium of [18], wherein the information on the identified piece of equipment comprises at least one of a serial number of the identified piece of equipment, a location of the identified piece of equipment, and a MAC address of the identified piece of equipment, and wherein the information on the replacement for the identified piece of equipment comprises at least one of a serial number of the replacement for the identified piece of equipment and a MAC address of the replacement for the identified piece of equipment.
[20] The non-transitory computer readable medium of claim [18] or [19], wherein the information on the identified piece of equipment and the information on the replacement for the identified piece of equipment are automatically retrieved from the EMS.

What is claimed is:

1. A system for managing resources, the system comprising:
a radio access network (RAN) comprising a plurality of pieces of equipment;
an equipment monitoring system (EMS) configured to monitor the plurality of pieces of equipment and provide system resources in support of the operation of the plurality of pieces of equipment;
at least one memory configured to store at least one instruction; and
at least one processor configured to access the at least one memory and execute the at least one instruction to:
monitor the plurality of pieces of equipment,
identify a piece of equipment among the plurality of pieces of equipment that is not functioning in a normal manner,
on identifying the piece of equipment that is not functioning in a normal manner, initiate an alert to a user and generate a request to decommission the identified piece of equipment,
request approval of the request to decommission the identified piece of equipment and to commission a replacement for the identified piece of equipment, and
based on receiving approval of the request to decommission the identified piece of equipment and to commission a replacement for the identified piece of equipment, initiate decommissioning of the identified piece of equipment and commissioning of the replacement for the identified piece of equipment.

2. The system of claim 1, wherein the decommissioning of the identified piece of equipment comprises:
identification of EMS system resources allocated to the identified piece of equipment, and
deallocation of the identified EMS system resources.

3. The system of claim 2, wherein the commissioning of the replacement for the identified piece of equipment comprises:
allocation of the identified EMS system resources to the replacement for the identified piece of equipment, and
monitoring the replacement for the identified piece of equipment by the EMS.

4. The system of claim 1, wherein the request to decommission the identified piece of equipment comprises at least one of information on the identified piece of equipment and information on the replacement for the identified piece of equipment.

5. The system of claim 4,
wherein the information on the identified piece of equipment comprises at least one of a serial number of the identified piece of equipment, a location of the identified piece of equipment, and a MAC address of the identified piece of equipment, and
wherein the information on the replacement for the identified piece of equipment comprises at least one of a serial number of the replacement for the identified piece of equipment and a MAC address of the replacement for the identified piece of equipment.

6. The system of claim 4, wherein the information on the identified piece of equipment and the information on the replacement for the identified piece of equipment are automatically retrieved from the EMS.

7. The system of claim 4, wherein the information on the identified piece of equipment and the information on the replacement for the identified piece of equipment are provided by a user.

8. A method for managing resources of a radio access network (RAN), the method comprising:
monitoring the RAN;
identifying a piece of equipment within the RAN that is not functioning in a normal manner;
based on identifying the piece of equipment that is not functioning in a normal manner, initiating an alert to a user and generating a request to decommission the identified piece of equipment;
requesting approval of the request to decommission the identified piece of equipment and to commission a replacement for the identified piece of equipment; and
based on receiving approval of the request to decommission the identified piece of equipment and to commission a replacement for the identified piece of equipment, initiating decommissioning of the identified piece of equipment and commissioning of the replacement for the identified piece of equipment.

9. The method of claim 8, wherein the decommissioning of the identified piece of equipment comprises:
identifying equipment monitoring system (EMS) system resources allocated to the identified piece of equipment; and
deallocating the identified EMS system resources.

10. The method of claim 9, wherein the commissioning of the replacement for the identified piece of equipment comprises:
allocating the identified EMS system resources to the replacement for the identified piece of equipment; and
monitoring the replacement for the identified piece of equipment by the EMS.

11. The method of claim 8, wherein the request to decommission the identified piece of equipment comprises at least one of information on the identified piece of equipment and information on the replacement for the identified piece of equipment.

12. The method of claim 11,
wherein the information on the identified piece of equipment comprises at least one of a serial number of the identified piece of equipment, a location of the identified piece of equipment, and a MAC address of the identified piece of equipment, and
wherein the information on the replacement for the identified piece of equipment comprises at least one of a serial number of the replacement for the identified piece of equipment and a MAC address of the replacement for the identified piece of equipment.

13. The method of claim 11, wherein the information on the identified piece of equipment and the information on the replacement for the identified piece of equipment are automatically retrieved from the EMS.

14. The method of claim 11, wherein the information on the identified piece of equipment and the information on the replacement for the identified piece of equipment are provided by a user.

15. A non-transitory computer readable medium having instructions stored therein, which when executed by a processor cause the processor to execute a method of managing resources of a radio access network (RAN), the method comprising:
monitoring the RAN;
identifying a piece of equipment within the RAN that is not functioning in a normal manner;
based on identifying the piece of equipment that is not functioning in a normal manner, initiating an alert to a user and generating a request to decommission the identified piece of equipment;
requesting approval of the request to decommission the identified piece of equipment and to commission a replacement for the identified piece of equipment; and
based on receiving approval of the request to decommission the identified piece of equipment and to commission a replacement for the identified piece of equipment, initiating decommissioning of the identified piece of equipment and commissioning of the replacement for the identified piece of equipment.

16. The non-transitory computer readable medium of claim 15, wherein the decommissioning of the identified piece of equipment comprises:
identifying equipment monitoring system (EMS) system resources allocated to the identified piece of equipment; and
deallocating the identified EMS system resources.

17. The non-transitory computer readable medium of claim 16, wherein the commissioning of the replacement for the identified piece of equipment comprises:
allocating the identified EMS system resources to the replacement for the identified piece of equipment; and
monitoring the replacement for the identified piece of equipment by the EMS.

18. The non-transitory computer readable medium of claim 15, wherein the request to decommission the identified piece of equipment comprises at least one of information on the identified piece of equipment and information on the replacement for the identified piece of equipment.

19. The non-transitory computer readable medium of claim 18,
wherein the information on the identified piece of equipment comprises at least one of a serial number of the identified piece of equipment, a location of the identified piece of equipment, and a MAC address of the identified piece of equipment, and
wherein the information on the replacement for the identified piece of equipment comprises at least one of a serial number of the replacement for the identified piece of equipment and a MAC address of the replacement for the identified piece of equipment.

20. The non-transitory computer readable medium of claim 18, wherein the information on the identified piece of equipment and the information on the replacement for the identified piece of equipment are automatically retrieved from the EMS.
